(19) United States
(12) Patent Application Publication
(10) Pub. No.: US 2014/0055989 A1
(43) Pub. Date: Feb. 27, 2014

(54) L.E.D. LIGHT EMITTING ASSEMBLY WITH COMPOSITE HEAT SINK

(71) Applicant: Peter A. Hochstein, Troy, MI (US)

(72) Inventor: Peter A. Hochstein, Troy, MI (US)

(73) Assignee: RELUME TECHNOLOGIES, INC., Oxford, MI (US)

(21) Appl. No.: 13/816,350

(22) PCT Filed: Aug. 10, 2010
(86) PCT No.: PCT/US2010/044952

§ 371 Date: May 15, 2013

(51) Int. Cl. F21V 29/00

(52) U.S. Cl. CPC F21V 29/22
USPC 362/218

(57) ABSTRACT

A light emitting assembly includes an elongated heat sink 22 of aluminum material, a heat spreader 24 of a copper material disposed on the heat sink 22, and light emitting diodes 26 disposed on the heat spreader 24. An insulating layer 54 is disposed on the heat spreader 24 and a circuit 62 including a ribbon 64 extends continuously along the insulating layer 54 between the light emitting diodes 26. A conformal coating 70 is disposed over the circuit 62 so that the heat sink 22, conformal coating 70, the ribbon 64, the insulating layer 54, and the heat spreader 24 are sandwiched together. A reflector 72 is disposed around each of the light emitting diodes 26 for reflecting the light in a predetermined direction.

The present application is a non-provisional U.S. nationalization application, which claims the benefit of PCT application number PCT/US2010/044952 filed Aug. 10, 2010, entitled “L.E.D. LIGHT EMITTING ASSEMBLY WITH COMPOSITE HEAT SINK.”

### BACKGROUND OF THE INVENTION

1. Field of the Invention

The subject invention relates to a light emitting assembly of the type including light emitting diodes (L.E.D.s), and more particularly, to a lighting emitting assembly for avoiding high temperatures causing early degradation of the LEDs.

2. Description of the Prior Art

Light emitting assemblies including light emitting diodes are more efficient than other light sources, such those including high intensity discharge (HID) lamps. Typically a fifty percent (50%) energy savings is possible when light sources including HID lamps are replaced with properly designed L.E.D. light assemblies.

An example of such an L.E.D. light assembly is disclosed in P.C.T. Patent Application Serial No. PCT/US2008/65874 to the present inventor, Peter A. Hochstein, which is directed to effective thermal management of the light emitting assembly. The '874 application discloses an elongated heat sink of a thermally conductive material extending between opposite ends. The light emitting assembly of the '874 application also includes an insulating layer of electrically insulating material disposed on the heat sink, a plurality of light emitting diodes disposed on the insulating layer, and a circuit disposed on the insulating layer along the heat sink between the light emitting diodes and the ends for electrically interconnecting the light emitting diodes. Such an L.E.D. light emitting assembly typically has a service life of about 70,000 hours and an expected service life exceeding 10-12 years, compared to a nominal 2-3 year life of HID light sources.

Another example of an L.E.D. light emitting assembly directed to effective thermal management is disclosed in U.S. application Ser. No. 11/181,674 to Nicholas Edwards. The '674 application discloses a heat sink of a first thermally conductive material, a heat spreader of a second thermally conductive material disposed on the heat sink, and an insulating layer of electrically insulating material disposed on the heat spreader. The '674 application also discloses a plurality of light emitting diodes each supported by an individual copper mount disposed on the insulating layer. A circuit of electrical wires is spaced from the insulating layer and extends between the light emitting diodes for electrically interconnecting the light emitting diodes.

Until recently, the light emitting diodes of the light emitting assemblies have operated at a power of 1-2 Watts. However, it is now desirable to use advanced light emitting diodes operating at a higher power of at least 3.0 Watts because such high power light emitting diodes offer significant optical and cost advantages. These high power light emitting diodes typically produce undesirable local heat loads that exceed 3.0 Watts in an area of 16 square millimeters. The local heat loads result in a junction temperature that is detrimental to the longevity of the L.E.D. diodes and light emitting assemblies.

### SUMMARY OF THE INVENTION

The subject invention provides an L.E.D. light emitting assembly comprising such a heat sink, heat spreader, insulating layer, light emitting diodes, circuit, and characterized by the circuit including a ribbon extending continuously along the insulating layer between the light emitting diodes for electrically interconnecting the light emitting diodes in series whereby the heat sink and the ribbon and the insulating layer and the heat spreader are sandwiched together in contact with one another.

### ADVANTAGES OF THE INVENTION

The light emitting assembly meets the need for more effective thermal management arising from use of the high power light emitting diodes. The arrangement of the components of the light emitting assembly, including the heat sink and the ribbon and the insulating layer and the heat spreader being sandwiched together in contact with one another provides improved thermal management for assemblies employing traditional light emitting diodes and effective thermal management for assemblies employing the high power light emitting diodes. The light emitting assembly reduces the junction temperature of high power light emitting diodes operating at a power of at least 3.0 Watts by a factor of typically 15%, compared to the prior art light assemblies. The light emitting assembly permits operation at a light emitting diode junction temperature of 70° C. while the prior art light assemblies typically operate at a light emitting diode junction temperature in the 85° C. range. The light emitting assembly is capable of employing the high power light emitting diodes and achieving the improved optical performance at lower cost, while maintaining the expected 10-12 year longevity of the light emitting assembly.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a first embodiment of an L.E.D. light emitting assembly of the subject invention;

FIG. 2A is a cross sectional view taken along line 2-2 of FIG. 1;

FIG. 2B is a cross sectional view taken along 2-2 of FIG. 1 including a conformal coating;

FIG. 3 is a perspective view of a second embodiment of an L.E.D. light emitting assembly of the subject invention;

FIG. 4 is a cross sectional view taken along line 4-4 of FIG. 3; and

FIG. 5 is a cross sectional view of a third embodiment of an L.E.D. light emitting assembly of the subject invention.

### DETAILED DESCRIPTION OF THE INVENTION

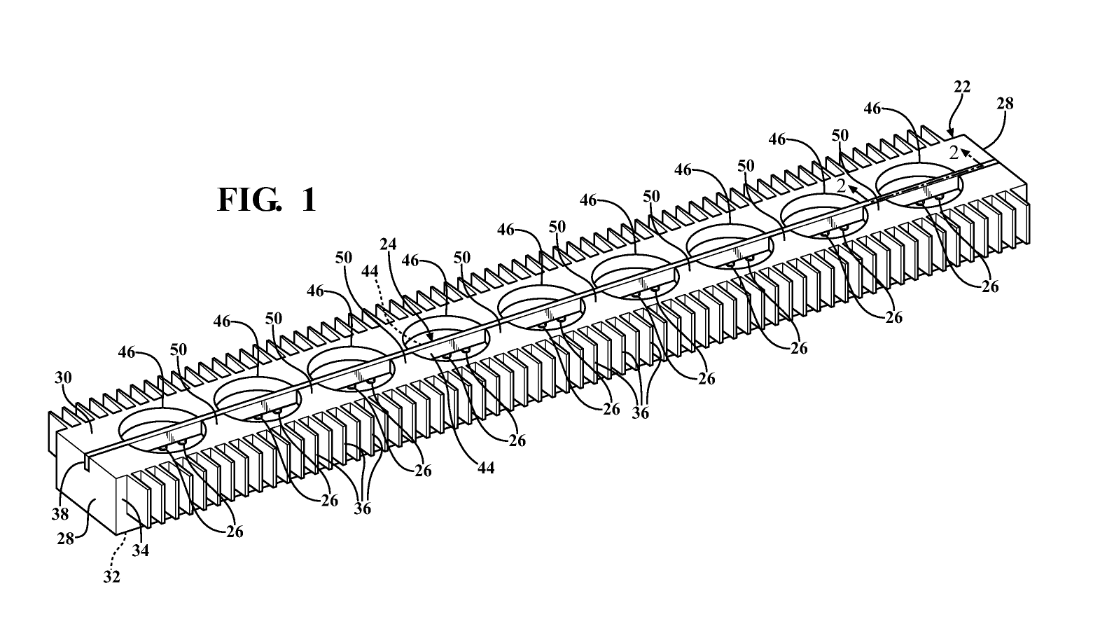

Referring to the Figures, where like numerals indicated like or corresponding parts throughout the several view, three embodiments of an L.E.D. light emitting assembly constructed in accordance with the subject invention are respectively shown in FIGS. 1-2B, 3-4, and 5. The light emitting assembly includes a composite heat dissipating structure, including an elongated heat sink 22 of a first thermally conductive material, such as aluminum, and a heat spreader 24 of a second thermally conductive material of greater thermal conductivity, such as copper, disposed on the heat sink 22. A plurality of light emitting diodes 26 are disposed on the heat spreader 24 so that heat from the light emitting diodes 26 is transmitted through the heat spreader 24 to the heat sink 22 and outwardly of the light emitting assembly.

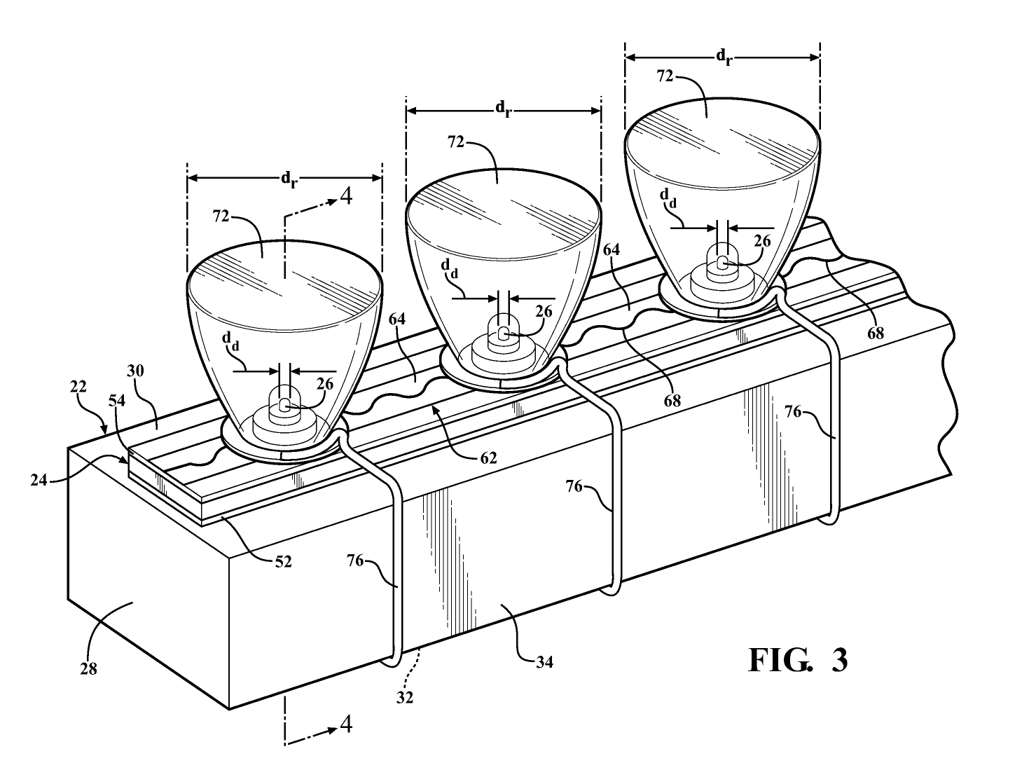

The elongated heat sink 22, generally indicated, is formed of the first thermally conductive material, such as homogeneous aluminum or an aluminum alloy, extending between opposite ends 28. The heat sink 22 presents a first surface 30 and an oppositely facing second surface 32. The heat sink 22 includes heat sink side walls 34 interconnecting the first surface 30 and the second surface 32 between the ends 28 which may present a generally rectangular shape, as shown in FIGS. 1 and 3. A plurality of fins 36 typically extend transversely from the heat sink side walls 34 and are spaced from one another between the ends 28 for transferring heat away from the heat sink 22 to surrounding ambient air. The heat sink 22 may be formed by extruding a continuous strip of the first thermally conductive material. However, the heat sink 22 can also be formed by molding or casting.

In one embodiment, as shown in FIGS. 1 and 5, the heat sink 22 defines an elongated slot 38 extending transversely into the first surface 30 of the heat sink 22 and continuously between the ends 28 for retaining the heat spreader 24. The elongated slot 38 is disposed inwardly of the heat sink side walls 34 between the ends 28. The elongated slot 38 provides for convenient placing of the heat spreader 24 during manufacture of the light emitting assembly.

The heat spreader 24, generally indicated, is disposed on the heat sink 22. The heat spreader 24 is formed of the second thermally conductive material having a thermal conductivity greater than the thermal conductivity of the first thermally conductive material of the heat sink 22. For example, the heat sink 22 can be formed of aluminum having a thermal conductivity of 237 W/m K and the heat spreader 24 can be formed of copper or silver having a thermal conductivity of 400 W/m K. The high thermal conductivity of the heat spreader 24 allows heat from the light emitting diodes 26 to preferentially travel through the heat spreader 24, away from the light emitting diodes 26, and to the aluminum heat sink 22.

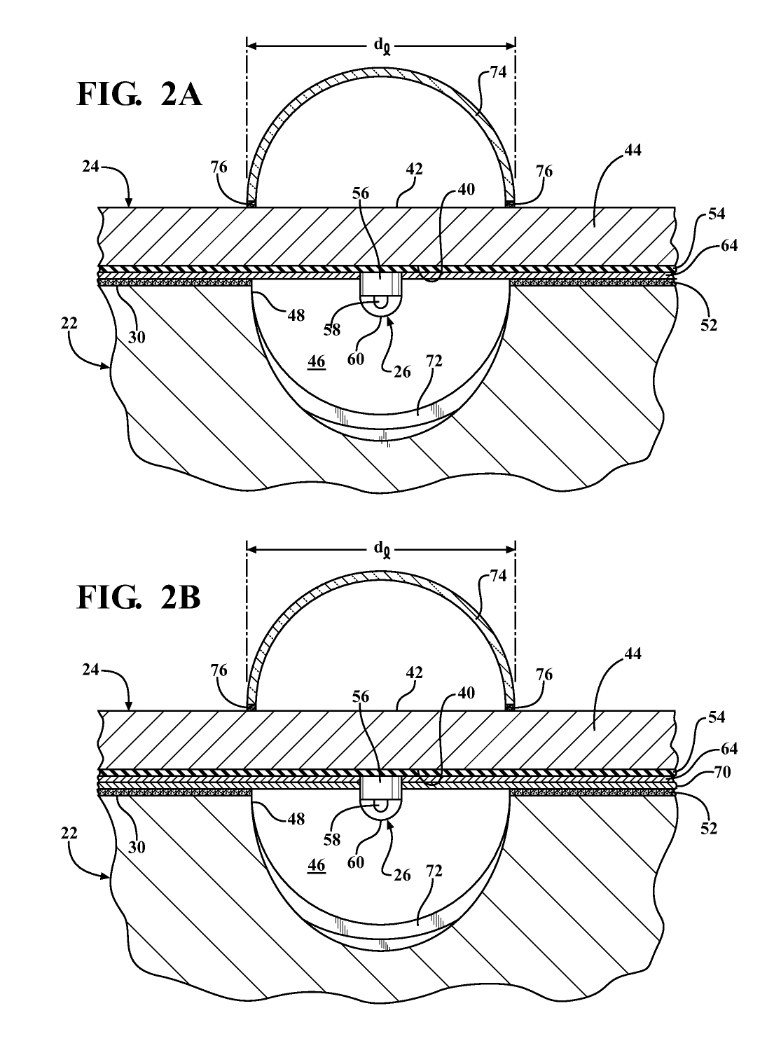

The heat spreader 24 presents an L.E.D. mounting surface 40 and an oppositely facing heat dissipating surface 42, as shown in FIGS. 2A, 2B 4, and 5. The L.E.D. mounting surface 40 extends parallel to the first surface 30 of the heat sink 22. The heat spreader 24 includes heat spreader side walls 44 interconnecting the L.E.D. mounting surface 40 and the heat dissipating surface 42. The heat spreader side walls 44 are disposed inwardly of the heat sink side walls 34.

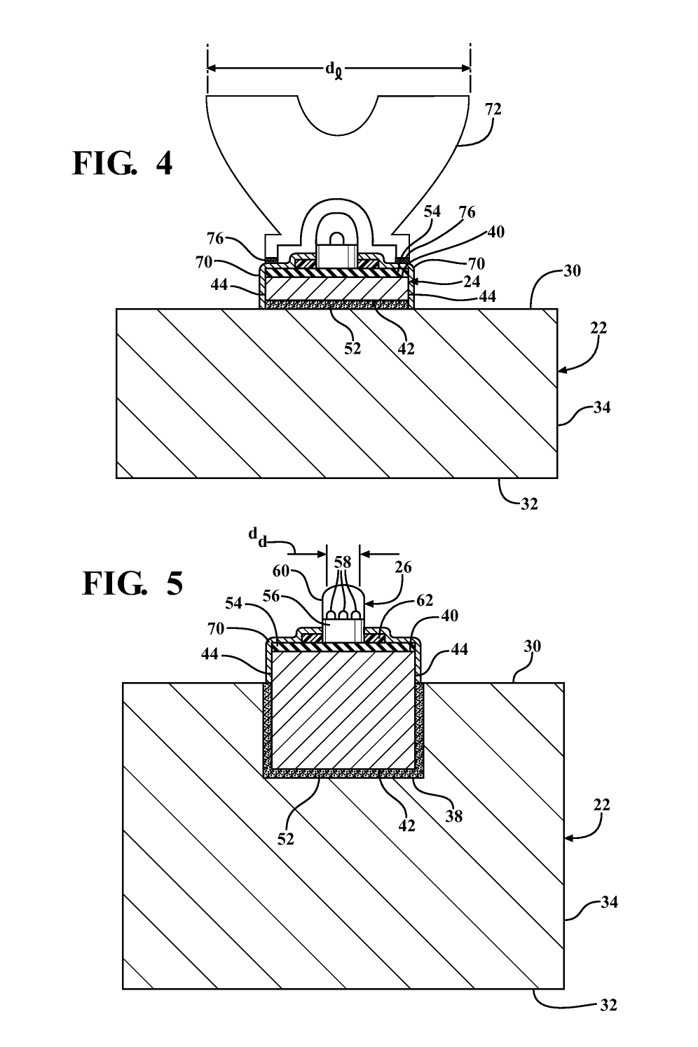

In one embodiment, as shown in FIGS. 3 and 4, the heat dissipating surface 42 of the heat spreader 24 extends continuously along the first surface 30 of the heat sink 22 between the ends 28 for transferring heat from the heat spreader side walls 44 to the heat sink 22. The L.E.D. mounting surface 40 of the heat spreader 24 is disposed outwardly of the first surface 30 of the heat sink 22. The L.E.D. mounting surface 40 and light emitting diodes 26 face outwardly of the heat sink 22 and the light emitting assembly. In the embodiment of FIGS. 3 and 4, the L.E.D. mounting surface 40 is non-planar with the first surface 30 of the heat sink 22. However, the L.E.D. mounting surface 40 may be planar with the first surface 30 of the heat sink 22.

When the heat sink 22 includes the elongated slot 38, the heat spreader 24 is disposed in the elongated slot 38 and extends continuously along the elongated slot 38 between the ends 28. As shown in FIGS. 1 and 5, the heat sink 22 extends along the heat dissipating surface 42 of the heat spreader 24 and along at least a portion of the heat spreader side walls 44 for transferring heat from the heat spreader side walls 44 to the heat sink 22.

In the embodiment of FIG. 5, wherein the heat sink 22 includes the elongated slot 38, the heat sink 22 extends continuously along the heat dissipating surface 42 and continuously along a portion of the heat spreader side walls 44. The L.E.D. mounting surface 40 of the heat spreader 24 is disposed outwardly of the first surface 30 of the heat sink 22. The L.E.D. mounting surface 40 and the light emitting diodes 26 face outwardly of the elongated slot 38. In the embodiment of FIG. 5, the L.E.D. mounting surface 40 is non-planar with the first surface 30 of the heat sink 22.

In another embodiment, shown in FIGS. 1, 2A, and 2B, wherein the heat sink 22 includes the elongated slot 38, the heat sink 22 extends continuously along the heat spreader side walls 44 and along portions of the L.E.D. mounting surface 40. As shown in FIGS. 1, 2A, and 2B, the L.E.D. mounting surface 40 of the heat spreader 24 is non-planar with the first surface 30 of the heat sink 22. The heat dissipating surface 42 is planar with the first surface 30 of the heat sink 22. The L.E.D. mounting surface 40 and the light emitting diodes 26 face inwardly, which will be discussed further below.

In the embodiment of FIGS. 1, 2A, and 2B, the heat sink 22 also defines a plurality of openings 46 each extending transversely into the first surface 30 of the heat sink 22 and spaced from one another between the ends 28. Each of the openings 46 presents a concave profile 48. The first surface 30 of the heat sink 22 includes a plurality of heat transfer bridges 50 spacing each of the openings 46 from the adjacent one. The heat transfer bridges 50 of the heat sink 22 define the elongated slot 38 and the elongated slot 38 extends continuously across the openings 46 between the ends 28. The heat transfer bridges 50 transfer heat generated by the light emitting diodes 26 from the heat spreader 24 to the heat sink side walls 34 and outwardly of the assembly. As discussed above, the elongated slot 38 retains the heat spreader 24. As shown in FIGS. 1, 2A, and 2B, the L.E.D. mounting surface 40 of the heat spreader 24 extends along the elongated slot 38 through the openings 46 between the ends 28. The heat dissipating surface 42 of the heat spreader 24 is planar with the first surface 30 of the heat sink 22 so that the heat sink 22 extends continuously along the heat spreader side walls 44 from the L.E.D. mounting surface 40 to the heat dissipating surface 42 for transferring heat from the heat spreader side walls 44 to the heat sink 22.

The light emitting assembly includes a thermal transfer adhesive 52 material coupling the heat spreader 24 to the heat sink 22. The thermal transfer adhesive 52 adheres the heat spreader 24 to the heat sink 22. The thermal transfer adhesive 52 is disposed between the heat sink 22 and the heat spreader 24. In the embodiments of FIGS. 1, 2A, 2B, and 5, the thermal transfer adhesive 52 is disposed in the elongated slot 38. In other words, the elongated slot 38 retains the thermal transfer adhesive 52 and the heat spreader 24. In the embodiments of FIGS. 1, 2A, and 2B, the thermal transfer adhesive 52 is disposed between the L.E.D. mounting surface 40 of the heat spreader 24 and the first surface 30 of the heat sink 22. In the embodiment of FIG. 5, the thermal transfer adhesive 52 is disposed between the first surface 30 of the heat sink 22 and heat dissipating surface 42 and between the first surface 30 and the heat spreader side walls 44. In the embodiment of FIGS. 3 and 4 the thermal transfer adhesive 52 is disposed between the first surface 30 of the heat sink 22 and the heat dissipating surface 42 of the heat spreader 24. The thermal transfer adhesive 52 is typically a filled epoxy material, but can include other materials known in the art.

The light emitting assembly includes an insulating layer 54 of electrically insulating material disposed over the L.E.D. mounting surface 40 of the heat spreader 24 between the ends 28. The insulating layer 54 electrically isolates the light emitting diodes 26 from the heat sink 22 and from one another to prevent short circuiting the light emitting diodes 26. Examples of the electrically insulating material include epoxy based, polyamide, polyethelene naphtalate, polytetrafluoroethylene (PTFE) based, or ceramic materials.

The light emitting diodes 26 are disposed on the insulating layer 54 along the L.E.D. mounting surface 40 of the heat spreader 24, as shown in FIGS. 1 and 3. Each of the light emitting diodes 26 are spaced from the next adjacent of the light emitting diodes 26 along the heat spreader 24 for transferring heat from the light emitting diodes 26 through the heat spreader 24 to the heat sink 22. Each of the light emitting diodes 26 includes a substrate 56 of an electrically insulating ceramic material disposed on the insulating layer 54 and at least one die 58 disposed on the substrate 56. The light emitting diode 26 has a die dimension d_{d}, which is the greatest dimension of the die 58, typically the area extending along the heat spreader 24. When the light emitting diode 26 includes a plurality of die 58, the die dimension d_{d} is equal to the sum of the die dimensions d_{d} of each of the dies 58. For example, the die dimension d_{d} of a high power light emitting diode 26, designed to operate at a power of about 3.0 Watts, is about 1.4 millimeters by 1.4 millimeters. Each of the light emitting diodes 26 also have a cover 60 being light transmissive and disposed over the at least one die 58.

The light emitting diodes 26 can include traditional light emitting diodes 26, operating at a power of about two Watts or recently developed high power light emitting diodes 26 operating at a power of at least 3.0 Watts, which achieve improved optical performance over the traditional light emitting diodes 26 at lower cost.

In the embodiment of FIGS. 1, 2A, and 2B, the light emitting diodes 26 are disposed on the L.E.D. mounting surface 40 in each of the openings 46 of the heat sink 22 and the light emitting diodes 26 face inwardly toward the concave profile 48 of the openings 46. In the embodiment of FIGS. 3, 4, and 5, the light emitting diodes 26 are disposed on the L.E.D. mounting surface 40 and face outwardly away from the heat sink 22.

A circuit 62 electrically interconnects the light emitting diodes 26 to one another in series along the L.E.D. mounting surface 40 between the ends 28. As best shown in FIG. 3, the circuit 62 is disposed on the insulating layer 54 along the L.E.D. mounting surface 40 between the light emitting diodes 26 and the ends 28. The circuit 62 includes a ribbon 64 extending continuously along the insulating layer 54 between the light emitting diodes 26 for electrically interconnecting the light emitting diodes 26 in series.

The ribbon 64 includes an electrically conductive material electrically interconnecting the light emitting diodes 26. The ribbon 64 typically includes a foil of a copper material extending continuously along the insulating layer 54 between the light emitting diodes 26. In another embodiment, the ribbon 64 includes a printed conductive material extending continuously along the insulating layer 54 between the light emitting diodes 26. In yet another embodiment, the ribbon 64 includes a conductive polymer material extending along the insulating layer 54 between the light emitting diodes 26, a plurality of gaps 68 in the conductive polymer material between the light emitting diodes 26, and the electrically conductive material disposed in each of the gaps 68 for electrically interconnecting the light emitting diodes 26. In yet another embodiment the ribbon 64 is formed of a conductive polymer material including particles of the electrically conductive material for electrically interconnecting the light emitting diodes 26.

The heat sink 22 and the thermal transfer adhesive 52 and the ribbon 64 and the insulating layer 54 and the heat spreader 24 are sandwiched together in contact with one another, as shown in FIGS. 2A, 3, and 5. In the embodiment of FIG. 2A, including the openings 46 and the light emitting diodes 26 facing inwardly, the thermal transfer adhesive 52 is sandwiched between the ribbon 64 and the heat sink 22. In the embodiments of FIGS. 4 and 5, wherein the light emitting diodes 26 face outwardly, the thermal transfer adhesive 52 is sandwiched between the heat sink 22 and the heat spreader 24.

The arrangement of the components of the light emitting assembly, including the heat sink 22 and the ribbon 64 and the insulating layer 54 and the heat spreader 24 being sandwiched together in contact with one another provides improved thermal management for assemblies employing the light emitting diodes 26 traditionally employed. The arrangement of the components of the light emitting assembly also provides effective thermal management for assemblies employing light emitting diodes 26 having the higher power of at least 3.0 Watts. The arrangement allows heat from the light emitting diodes 26 to effectively be transmitted from the light emitting diode 26 to the heat spreader 24 and then to the heat sink 22. The arrangement of the light emitting assembly reduces the junction temperature of high power light emitting diodes 26 operating at a power of around 3.0 Watts or greater by a factor of approximately 15%, compared to the prior art light assemblies. The light emitting assembly is capable of employing the high power light emitting diodes 26 to achieve the improved optical performance while maintaining the expected 10-12 year longevity of the light emitting assembly.

The light emitting assembly may also include a conformal coating 70 disposed continuously over the L.E.D. mounting surface 40 and the insulating layer 54 and the circuit 62 between the ends 28. The conformal coating 70 can be applied by dipping, spraying, flow coating 70, or robotic dispensing. The conformal coating 70 provides environmental and mechanical protection to extend the life of the components and circuitry. In the embodiment of FIGS. 2B, 3, 4, and 5, the heat sink 22 and the thermal transfer adhesive 52 and the conformal coating 70 and the ribbon 64 and the insulating layer 54 and the heat spreader 24 are sandwiched together in contact with one another. In the embodiment of FIG. 2B, including the openings 46 and the light emitting diodes 26 facing inwardly, the thermal transfer adhesive 52 is sandwiched between the conformal coating 70 and the heat sink 22.

The light emitting assembly may include a plurality of independent lenses 74 surrounding and covering each light emitting diode 26 for environmental protection. Each independent lens 74 is coupled to at least one of the heat sink 22 and the heat spreader 24. In the embodiments of FIGS. 2A and 2B, each independent lens 74 is disposed on and extends transversely from the first surface 30 of the heat sink 22 and the heat dissipating surface 42 of the heat spreader 24 around one of the openings 46 and the light emitting diode 26. An attachment 76 couples each of the independent lenses 74 to at least one of the heat sink 22 and the heat spreader 24. The attachment 76 coupling the independent lens 74 to the heat sink 22 and the heat spreader 24 typically includes a spring clip or a glue, as shown in FIGS. 2A and 2B.

Each of the independent lenses 74 have a lens dimension d₁ of at least eight times greater than the die dimension d_{d} of the light emitting diode 26. For generally cone-shaped independent lenses 74, as shown in FIGS. 2A and 2B, the lens dimension d₁ is the greatest diameter of the lens 74. For example, when the die 58 have a die dimension d_{d} of about 1.4 millimeters by 1.4 millimeters, the independent lens 74 has a lens dimension d₁ of about 24 millimeters.

The light emitting assembly also includes a reflector 72 disposed adjacent each one of the light emitting diodes 26 for reflecting the light emitting from the light emitting diode 26 in a predetermined direction. The reflector 72 collects the light emitting from the light emitting diodes 26 and directs the light in a predetermined direction. The reflector 72 improves the beam steering efficiency of the light emitting diode 26. The reflector 72 typically captures more than 90% of the light generated by the light emitting diode 26. The reflector 72 can employ total internal reflection (TIR) to capture and direct the light.

In the embodiments of FIGS. 2A and 2B, each reflector 72 is disposed along the concave profile 48 of one of the openings 46 for collecting the light emitting from the light emitting diode 26 and directing the light outwardly of the opening 46. In the embodiments of FIGS. 2A and 2B, the reflectors 72 are separate from and covered by the independent lens 74. In one embodiment, as shown in FIGS. 3 and 4, the reflector 72 surrounds and covers the light emitting diode 26 and provides environmental protection so that the independent lens 74 is not needed.

In the embodiment of FIGS. 3 and 4, the reflector 72 is disposed on and extends transversely from the L.E.D. mounting surface 40 of the heat spreader 24 around one of the light emitting diodes 26. The attachment 76, such as the glue or the spring clip, couples the reflector 72 to the heat sink 22 and the heat spreader 24, as shown in FIGS. 3 and 4.

In the embodiment of FIGS. 3 and 4, wherein the reflectors 72 surround the light emitting diodes 26 and provide environmental protection, each of the reflectors 72 have a reflector dimension dᵣ. The reflector dimension dᵣ is at least eight times greater than the die dimension d_{d} of the light emitting diode 26. For generally cone-shaped reflectors 72, as shown in FIGS. 3 and 4, the reflector dimension dᵣ is the greatest diameter of the reflector 72. For example, when the die 58 have a die dimension d_{d} of about 1.4 millimeters by 1.4 millimeters, the reflectors 72 has a reflector dimension dᵣ of about 24 millimeters.

Obviously, many modifications and variations of the present invention are possible in light of the above teachings and may be practiced otherwise than as specifically described while within the scope of the appended claims. That which is prior art in the claims precedes the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover 60 any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims. In addition, the reference numerals in the claims are merely for convenience and are not to be read in any way as limiting.

ELEMENT LIST

| Element Symbol | Element Name |
|---|---|
| 22 | heat sink |
| 24 | heat spreader |
| 26 | light emitting diodes |
| 28 | ends |
| 30 | first surface |
| 32 | second surface |
| 34 | heat sink side walls |
| 36 | fins |
| 38 | elongated slot |
| 40 | L.E.D. mounting surface |
| 42 | heat dissipating surface |
| 44 | heat spreader side walls |
| 46 | openings |
| 48 | concave profile |
| 50 | heat transfer bridges |
| 52 | thermal transfer adhesive |
| 54 | insulating layer |
| 56 | substrate |
| 58 | die |
| 60 | covers |
| 62 | circuit |
| 64 | ribbon |
| 68 | gap |
| 70 | coating |
| 72 | total internal reflector |
| 74 | lens |
| 76 | attachments |
| d_{d} | die dimension |
| dₗ | lens dimension |
| dᵣ | reflector dimension |

1. An L.E.D. light emitting assembly comprising;
an elongated heat sink (22) of a first thermally conductive material extending between opposite ends (28),
a heat spreader (24) of a second thermally conductive material disposed on said heat sink (22),
said second thermally conductive material of said heat spreader (24) having a thermal conductivity greater than the thermal conductivity of said first thermally conductive material of said heat sink (22),
an insulating layer (54) of electrically insulating material disposed on said heat spreader (24),
a plurality of light emitting diodes (26) disposed on said insulating layer (54),
a circuit (62) disposed on said insulating layer (54) along said heat spreader (24) between said light emitting diodes (26) and said ends (28) for electrically interconnecting said light emitting diodes (26), and
characterized by
said circuit (62) including a ribbon (64) extending continuously along said insulating layer (54) between said light emitting diodes (26) for electrically interconnecting said light emitting diodes (26) in series whereby said heat sink (22) and said ribbon (64) and said insulating layer (54) and said heat spreader (24) are sandwiched together in contact with one another.

2. An assembly as set forth in claim 1 including a thermal transfer adhesive (52) coupling said heat spreader (24) to said heat sink (22).

3. An assembly as set forth in claim 2 wherein said thermal transfer adhesive (52) is sandwiched between said heat sink (22) and said heat spreader (24).

4. An assembly as set forth in claim 2 wherein said thermal transfer adhesive (52) is sandwiched between said heat sink (22) and said ribbon (64).

5. An assembly as set forth in claim 1 wherein said ribbon (64) includes an electrically conductive material electrically interconnecting said light emitting diodes (26).

6. An assembly as set forth in claim 5 wherein said ribbon (64) includes a foil of a copper material extending continuously along said insulating layer (54) between said light emitting diodes (26).

7. An assembly as set forth in claim 1 including a conformal coating (70) disposed over said insulating layer (54) and said circuit (62) between said ends (28).

8. An assembly as set forth in claim 7 wherein said thermal transfer adhesive (52) is sandwiched between said heat sink (22) and said conformal coating (70).

9. An assembly as set forth in claim 1 wherein said ribbon (64) includes a conductive polymer material extending along said insulating layer (54) between said light emitting diodes (26) and a plurality of gaps (68) in said conductive polymer material between said light emitting diodes (26) and an electrically conductive material disposed in each of said gaps (68) electrically interconnecting said light emitting diodes (26).

10. An assembly as set forth in claim 1 wherein said heat sink (22) defines an elongated slot (38) extending transversely into said heat sink (22) and continuously between said ends (28) for retaining said heat spreader (24).

11. An assembly as set forth in claim 1 wherein said first thermally conductive material is aluminum and said second thermally conductive material is copper.

12. An assembly as set forth in claim 1 including a reflector (72) disposed adjacent each one of said light emitting diodes (26) for reflecting the light emitting from said light emitting diode (26) in a predetermined direction.

13. An assembly as set forth in claim 12 wherein said reflector (72) surrounds said light emitting diode (26) and has a reflector dimension (dᵣ) and wherein said light emitting diode (26) includes at least one die (58) having a die dimension (d_{d}) and said reflector dimension (dᵣ) is least eight times greater than said die dimension (d_{d}).

14. An assembly as set forth in claim 1 including an independent lens (74) surrounding each of said light emitting diodes (26) and having a lens dimensions (d₁) and wherein each of said light emitting diodes (26) includes at least one die (58) having a die dimension (d_{d}) and said lens dimension (d₁) is least eight times greater than said die dimension (d_{d}).

15. An assembly as set forth in claim 1 wherein said heat sink (22) presents a first surface (30) and an oppositely facing second surface (32) and heat sink side walls (34) interconnecting said first surface (30) and said second surface (32),
said heat spreader (24) presents an L.E.D. mounting surface (40) and an oppositely facing heat dissipating surface (42) and heat spreader side walls (44) interconnecting said L.E.D. mounting surface (40) and said heat dissipating surface (42), and
said heat spreader side walls (44) are disposed inwardly of said heat sink side walls (34).

16. An assembly as set forth in claim 1 wherein each of said light emitting diodes (26) includes a substrate (56) of an electrically insulating material disposed on said insulating layer (54).

17. An assembly as set forth in claim 1 wherein said heat sink (22) includes a plurality of heat transfer bridges (50) and defines a plurality of openings (46) extending transversely into said heat sink (22) and spaced from one another by said heat transfer bridges (50) between said ends (28) and said heat spreader (24) extends continuously along said openings (46) between said ends (28).

18. An assembly as set forth in claim 17 wherein said light emitting diodes (26) face inwardly toward said openings (46) and including a reflector (72) disposed in each of said openings (46) adjacent said light emitting diode (26) for reflecting the light emitting from said light emitting diode (26) in a predetermined direction.

19. An assembly as set forth in claim 17 including an independent lens (74) surrounding said opening (46) and said light emitting diode (26).

20. An L.E.D. light emitting assembly comprising;
an elongated heat sink (22) of a first thermally conductive material extending between opposite ends (28),
a heat spreader (24) of a second thermally conductive material disposed on said heat sink (22),
said second thermally conductive material of said heat spreader (24) having a thermal conductivity greater than the thermal conductivity of said first thermally conductive material of said heat sink (22),
said heat sink (22) including a plurality of heat transfer bridges (50) and defining a plurality of openings (46) extending transversely into said heat sink (22) and spaced from one another by said heat transfer bridges (50) between said ends (28),
said heat spreader (24) extending continuously along said openings (46) between said ends (28),
an insulating layer (54) of electrically insulating material disposed on said heat spreader (24),
a plurality of light emitting diodes (26) disposed on said insulating layer (54) at said openings (46) of said heat sink (22),
said light emitting diodes (26) facing inwardly toward said openings (46),
a circuit (62) disposed on said insulating layer (54) along said L.E.D. mounting surface (40) between said light emitting diodes (26) and said ends (28) for electrically interconnecting said light emitting diodes (26) in series,
a reflector (72) disposed in each of said openings (46) adjacent said light emitting diode (26) for directing the light outwardly of said openings (46), and
an independent lens (74) surrounding one of said openings (46) and said light emitting diode (26) for directing the light in a predetermined direction.

21. An assembly as set forth in claim 20 wherein said heat transfer bridges (50) of said heat sink (22) define an elongated slot (38) extending continuously across said openings (46) between said ends (28) for retaining said heat spreader (24).

22. An assembly as set forth in claim 20 wherein each of said openings (46) presents a concave profile (48).

23. An assembly as set forth in claim 20 wherein each of said light emitting diodes (26) includes at least one die (58) having a die dimension (d_{d}) and wherein each of said lenses (74) have a lens dimension (d₁) being at least eight times greater than said die dimension (d_{d}).

24. An assembly as set forth in claim 20 wherein said circuit (62) includes a ribbon (64) extending continuously along said insulating layer (54) between said light emitting diodes (26) for electrically interconnecting said light emitting diodes (26) in series.

25. An L.E.D. light emitting assembly comprising;
an elongated heat sink (22) of a first thermally conductive material extending between opposite ends (28),
said heat sink (22) presenting a first surface (30) and an oppositely facing second surface (32),
said heat sink (22) including heat sink side walls (34) interconnecting said first surface (30) and said second surface (32) between said ends (28),
said heat sink (22) including a plurality of fins (36) extending transversely from said heat sink side walls (34) and spaced from one another between said ends (28) for transferring heat away from said heat sink (22) to surrounding ambient air,
a heat spreader (24) of a second thermally conductive material coupled to said heat sink (22),
said second thermally conductive material of said heat spreader (24) having a thermal conductivity greater than the thermal conductivity of said first thermally conductive material of said heat sink (22),
said heat spreader (24) presenting an L.E.D. mounting surface (40) and an oppositely facing heat dissipating surface (42),
said L.E.D. mounting surface (40) of said heat spreader (24) extending parallel to said first surface (30) of said heat sink (22),
said heat spreader (24) including heat spreader side walls (44) interconnecting said L.E.D. mounting surface (40) and said heat dissipating surface (42),
an insulating layer (54) of electrically insulating material disposed over said L.E.D. mounting surface (40) of said heat spreader (24) between said ends (28),
a thermal transfer adhesive (52) of a filled epoxy material coupling said heat spreader (24) to said heat sink (22),
said thermal transfer adhesive (52) being sandwiched between said heat sink (22) and said heat spreader (24);
a plurality of light emitting diodes (26) disposed on said insulating layer (54) along said L.E.D. mounting surface (40) of said heat spreader (24),
each light emitting diode (26) spaced from the next adjacent of said light emitting diodes (26) along said heat spreader (24) for transferring heat from said light emitting diodes (26) through said heat spreader (24) to said heat sink (22),
each of said light emitting diodes (26) including a substrate (56) of an electrically insulating ceramic material disposed on said insulating layer (54),
each of said light emitting diodes (26) including at least one die (58) disposed on said substrate (56),
said die (58) having a die dimension (d_{d}) extending along said substrate (56),
said die dimension (d_{d}) being about 1.4 mm,
each of said light emitting diodes (26) including a cover (60) being light transmissive and disposed over said at least one single die (58),
said light emitting diodes (26) being electrically connected to one another in series along said L.E.D. mounting surface (40) between said ends (28),
a circuit (62) disposed on said insulating layer (54) along said L.E.D. mounting surface (40) between said light emitting diodes (26) and said ends (28) for electrically interconnecting said light emitting diodes (26),
a reflector (72) disposed adjacent each one of said light emitting diodes (26) for reflecting the light emitting from said light emitting diode (26) in a predetermined direction,
characterized by
said heat spreader side walls (44) being disposed inwardly of said heat sink side walls (34),
said circuit (62) including a ribbon (64) extending continuously along said insulating layer (54) between said light emitting diodes (26) for electrically interconnecting said light emitting diodes (26) in series, and
a conformal coating (70) disposed continuously over said L.E.D. mounting surface (40) and said insulating layer (54) and said circuit (62) between said ends (28) whereby said heat sink (22) and said thermal transfer adhesive (52) and said conformal coating (70) and said ribbon (64) and said insulating layer (54) and said heat spreader (24) are sandwiched together in contact with one another.

26. An assembly as set forth in claim 25 wherein said ribbon (64) includes an electrically conductive material electrically interconnecting said light emitting diodes (26).

27. An assembly as set forth in claim 25 wherein said ribbon (64) includes a foil of a copper material extending continuously along said insulating layer (54) between said light emitting diodes (26) for electrically interconnecting said light emitting diodes (26) in series.

28. An assembly as set forth in claim 25 wherein said ribbon (64) includes a conductive polymer material extending along said insulating layer (54) between said light emitting diodes (26) and a plurality of gaps (68) in said conductive polymer material between said light emitting diodes (26) and an electrically conductive material being disposed in each of said gaps (68) for electrically interconnecting said light emitting diodes (26).

29. An assembly as set forth in claim 25 wherein said ribbon (64) is formed of a conductive polymer material including particles of an electrically conductive material for electrically interconnecting said light emitting diodes (26).

30. An assembly as set forth in claim 25 wherein said heat sink (22) defines an elongated slot (38) extending transversely into said first surface (30) of said heat sink (22) and continuously between said ends (28) for retaining said thermal transfer adhesive (52) and said heat spreader (24),
said elongated slot (38) is disposed inwardly of said heat sink side walls (34) between said ends (28),
said heat spreader (24) is disposed in said elongated slot (38) and extends continuously along said first surface (30) of said heat sink (22) between said ends (28), and
said heat sink (22) extends along at least a portion of said heat spreader side walls (44) for transferring heat from said heat spreader side walls (44) to said heat sink (22).

31. An assembly as set forth in claim 30 wherein said heat dissipating surface (42) of said heat spreader (24) extends continuously along said elongated slot (38) between said ends (28) and said L.E.D. mounting surface (40) faces outwardly of said elongated slot (38),
said L.E.D. mounting surface (40) is non-planar with said first surface (30) of said heat sink (22),
said L.E.D. mounting surface (40) is disposed outwardly of said first surface (30) so that said heat sink (22) extends continuously along a portion of said heat spreader side walls (44) for transferring heat from said heat spreader side walls (44) to said heat sink (22),
said thermal transfer adhesive (52) is sandwiched between said first surface (30) of said heat sink (22) and said heat dissipating surface (42) of heat spreader (24),
said reflector (72) is disposed on and extends transversely from said L.E.D. mounting surface (40) of said heat spreader (24) around said light emitting diode (26),
said reflector (72) has a reflector dimension (dᵣ) at least eight times greater than said die dimension (d_{d}) of said die (58), and
an attachment (76) coupling each of said reflectors (72) to at least one of said heat sink (22) and said heat spreader (24).

32. An assembly as set forth in claim 30 wherein said heat sink (22) defines a plurality of openings (46) each extending transversely into said first surface (30) of said heat sink (22) and spaced from one another between said ends (28),
each of said openings (46) presents a concave profile (48),
said first surface (30) of said heat sink (22) includes a plurality of heat transfer bridges (50) spacing each of said openings (46) from the adjacent one,
said heat transfer bridges (50) of said heat sink (22) define said elongated slot (38) extending continuously across said openings (46) between said ends (28) for retaining said heat spreader (24),
said L.E.D. mounting surface (40) of said heat spreader (24) extends along said elongated slot (38) through said openings (46) between said ends (28) and said heat dissipating surface (42) faces outwardly of said elongated slot (38),
said thermal transfer adhesive (52) is sandwiched between said heat sink (22) and said coating (70);
said heat dissipating surface (42) of said heat spreader (24) is planar with said first surface (30) of said heat sink (22) so that said heat sink (22) extends continuously along said heat spreader side walls (44) from said L.E.D. mounting surface (40) to said heat dissipating surface (42) for transferring heat from said heat spreader side walls (44) to said heat sink (22),
said light emitting diodes (26) are disposed on said L.E.D. mounting surface (40) in each of said openings (46) of said heat sink (22),
said light emitting diodes (26) face toward said concave profile (48),
each of said reflectors (72) are disposed in one of said openings (46) adjacent said light emitting diode (26) along said concave profile (48) for collecting the light emitting from said light emitting diode (26) and directing the light outwardly of the opening (46), and
an independent lens (74) is disposed around and covers said opening (46) and said light emitting diode (26) and extends transversely from said first surface (30) of said heat sink (22) and said heat dissipating surface (42) of said heat spreader (24).

33. An assembly as set forth in claim 25 wherein said first thermally conductive material of said heat sink (22) has a thermal conductivity of at least 237 (W/m K).

34. An assembly as set forth in claim 33 wherein said first thermally conductive material is aluminum.

35. An assembly as set forth in claim 25 wherein said second thermally conductive material of said heat spreader (24) has a thermal conductivity of at least 400 (W/m K).

36. An assembly as set forth in claim 35 wherein said second thermally conductive material is copper.

37. An assembly as set forth in claim 35 wherein said second thermally conductive material is silver.

38. An assembly as set forth in claim 25 wherein said attachments (76) include spring clips.

39. An assembly as set forth in claim 25 wherein said attachments (76) include a glue.
